(19) United States
(12) Patent Application Publication
(10) Pub. No.: US 2020/0403336 A1
(43) Pub. Date: Dec. 24, 2020

(54) ELECTRICAL CONNECTOR HAVING U-SHAPED CONTACT PART WITH TWO CONTACTING PORTIONS INCLINED RELATIVE TO EACH OTHER FOR DRAWING IN A COMPLEMENTARY CONNECTOR DURING MATING

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: CEN XIE, Kunshan (CN); ZHI-WEI HE, Kunshan (CN)

(21) Appl. No.: 16/905,902

(22) Filed: Jun. 18, 2020

(30) Foreign Application Priority Data
Jun. 18, 2019 (CN) 201920919486.7

(51) Int. Cl. H01R 12/71; H01R 13/50; H01R 13/115

(52) U.S. Cl. CPC H01R 12/716; H01R 13/115; H01R 13/50

(57) ABSTRACT

An electrical connector includes: an insulative housing; and plural contacts secured to the insulative housing, each contact having a generally U-shaped part and a soldering part, the U-shaped part having a first contacting portion, a second contacting portion, and a connecting portion between the first contacting portion and the second contacting portion, wherein each of the first and second contacting portions has an outer contacting face, and one of the first and second contacting portions extends from the connecting portion to incline toward the other contacting portion.

### BACKGROUND OF THE INVENTION

### 1. Field of the Invention

The present invention relates to a board to board electrical connector including an insulative housing and a plurality of contacts secured to the insulative housing, wherein each contact has a generally U-shaped part with a first contacting portion, a second contacting portion, and a connecting portion therebetween, and wherein each contacting portion has an outer contacting face and one of the contacting portions so extends from the connecting portion as to assist in drawing in a complementary electrical connector.

### 2. Description of Related Art

Taiwan Patent No. M568518 and the counterpart U.S. Pat. No. 10,312,637 discloses an electrical connector including an insulative housing and a plurality of contacts secured to the insulative housing, wherein each contact has a generally U-shaped part with a first contacting portion, a second contacting portion, and a connecting portion therebetween, and wherein each contacting portion has an outer contacting face. The two contacting portions are arranged parallel to each other.

### SUMMARY OF THE INVENTION

An electrical connector comprises: an insulative housing; and a plurality of contacts secured to the insulative housing, each contact having a generally U-shaped part and a soldering part, the U-shaped part having a first contacting portion, a second contacting portion, and a connecting portion between the first contacting portion and the second contacting portion, wherein each of the first and second contacting portions has an outer contacting face, and one of the first and second contacting portions extends from the connecting portion to incline toward the other contacting portion.

### BRIEF DESCRIPTION OF THE DRAWINGS

FIG. 1 is a perspective view of an electrical connector assembly in accordance with the present invention;

FIG. 2 is a perspective view of a plug connector and a receptacle connector of the electrical connector assembly;

FIG. 3 is another perspective view of the plug connector and the receptacle connector;

FIG. 4 is an exploded view of the plug connector;

FIG. 5 is another exploded view of the plug connector;

FIG. 6 is an exploded view of the receptacle connector;

FIG. 7 is another exploded view of the receptacle connector;

FIG. 8 is a side view of a contact of the plug connector; and

FIG. 9 is a cross-sectional view of the electrical connector assembly taken along line A-A in FIG. 1.

### DETAILED DESCRIPTION OF THE PREFERRED EMBODIMENT

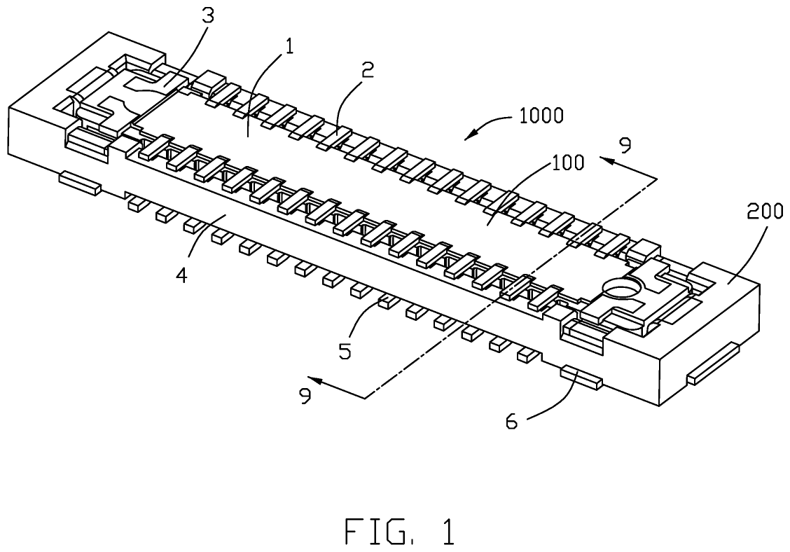

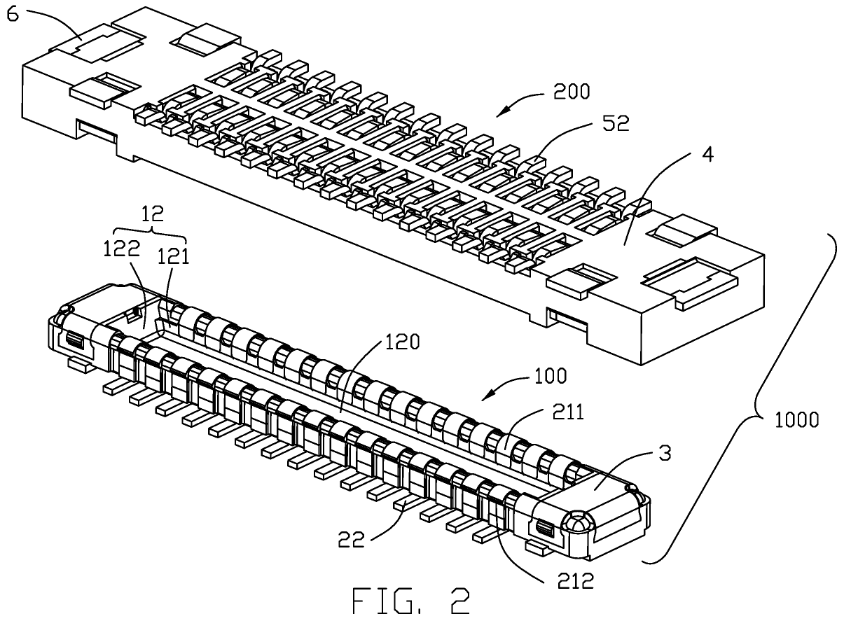

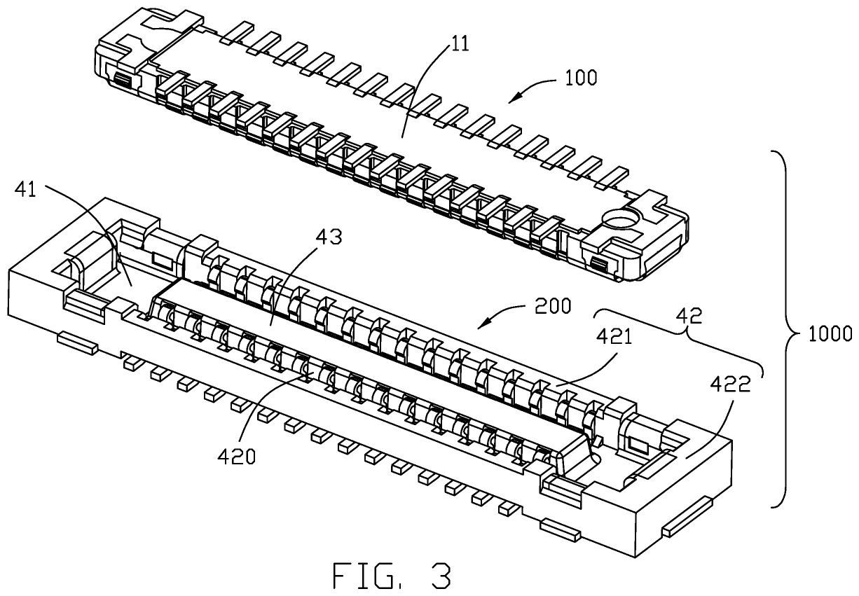

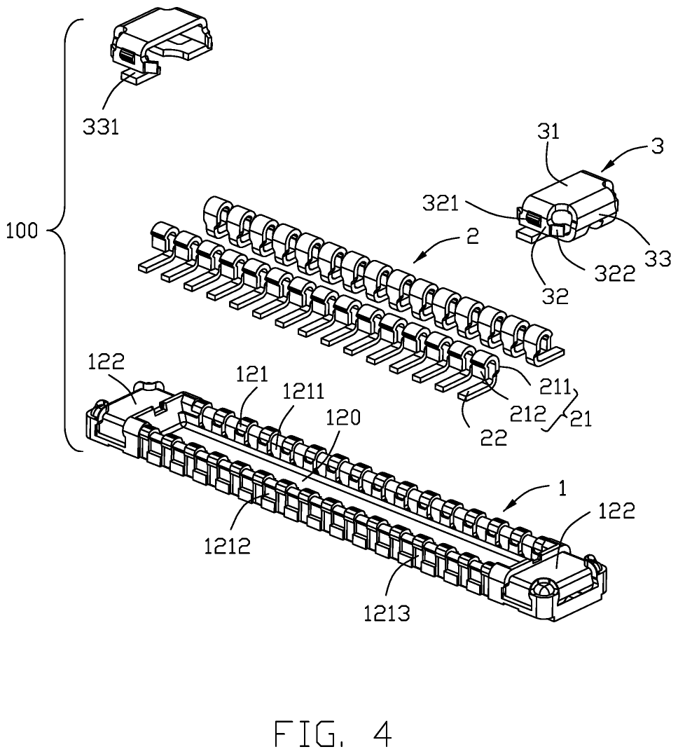

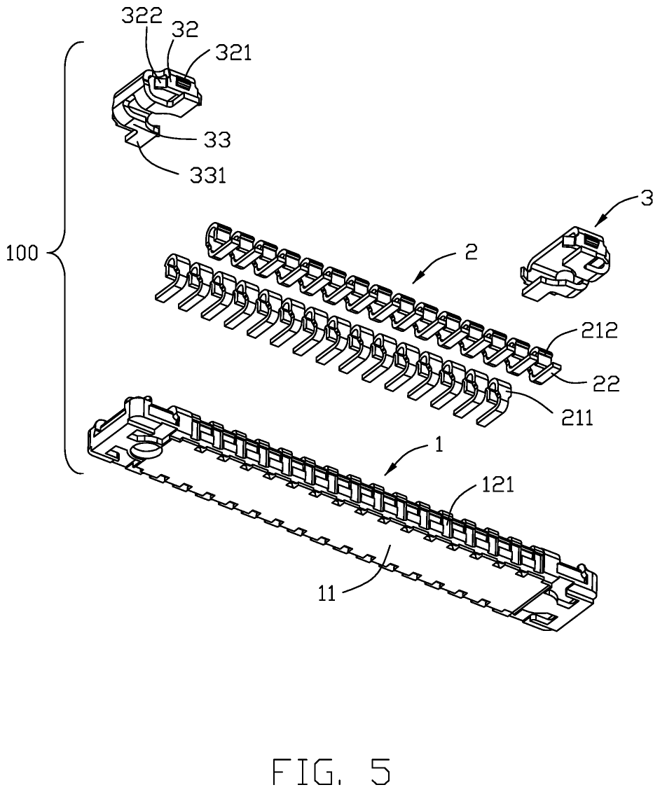

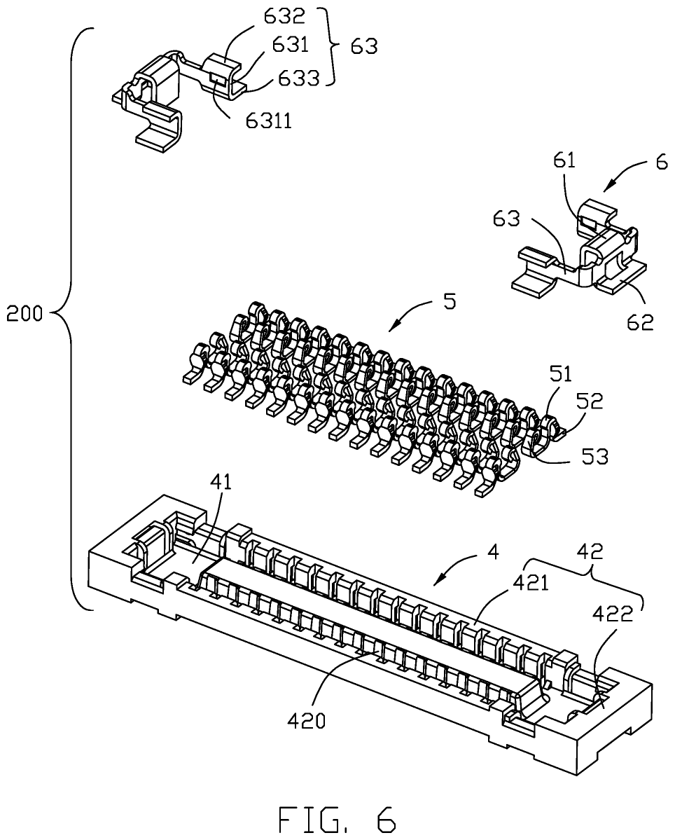

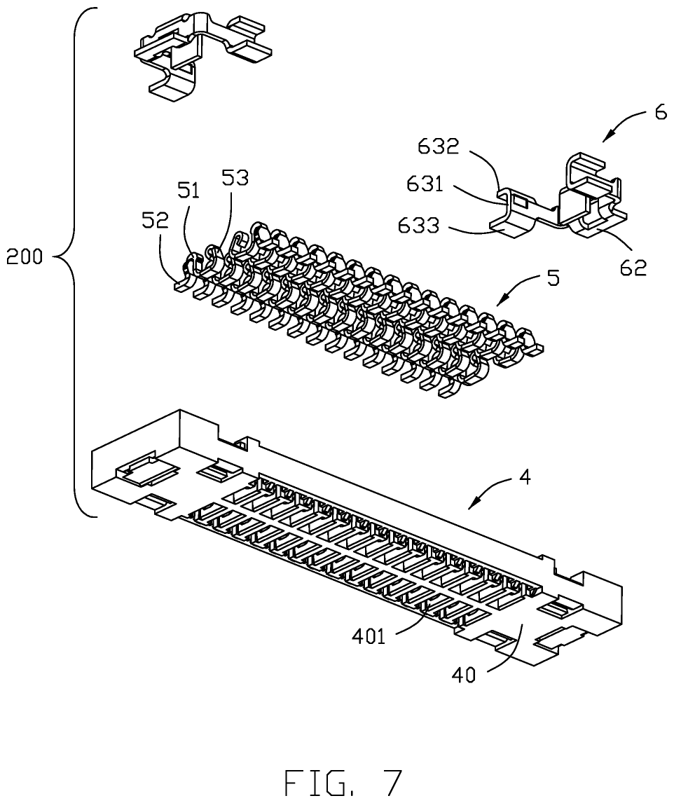

Referring to FIGS. 1-7, an electrical connector assembly 1000 includes a plug connector 100 and a mating receptacle connector 200. The plug connector 100 includes an elongate insulative housing 1, a plurality of contacts 2 secured to the insulative housing 1, and a pair of holding members 3 secured to two opposite ends of the insulative housing 1. The receptacle connector 200 includes an elongate insulative housing 4, a plurality of contacts 5 secured to the insulative housing 4, and a pair of holding members 6 secured to two opposite ends of the insulative housing 4.

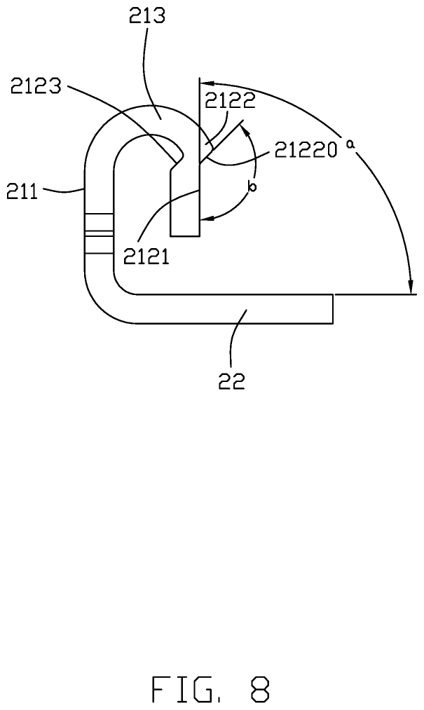

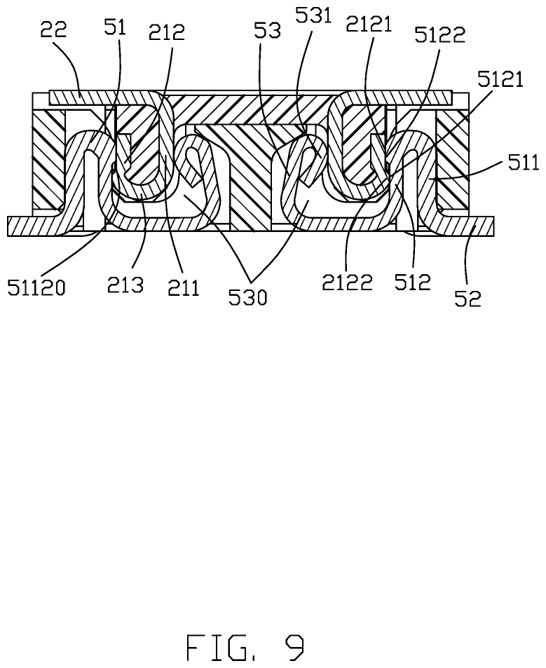

Also in conjunction with FIGS. 8-9, the insulative housing 1 has a bottom wall 11 and a peripheral wall 12. The contact 2 has a generally U-shaped securing part 21 and a horizontal soldering part 22. The securing part 21 has a first contacting portion 211, a second contacting portion 212, and a connecting portion 213 therebetween. The second contacting portion 212 has a planar outer contacting face 2121. The insulative housing 4 has a bottom wall 41 and a peripheral wall 42 defining a receiving space 420. The contact 5 has a generally U-shaped securing part 51, a soldering part 52 extending from a first portion 511 of the securing part 51, and a resilient engaging arm 53 extending from an opposite second portion 512 of the securing part 51 to form a receiving space 530. The engaging arm 53 has a curved portion 531. The second portion 512 of the securing part 51 has a planar outer contacting face 5121 and an inclined step S122. When mating the plug connector 100 and the receptacle connector 200, the curved portion 531 engages the first contacting portion 211 and the step S122 engages the planar outer contacting face 2121. To further deeply attract the contact 2 to the contact 5, an acute angle “a” formed between an imaginary plane defined by the planar outer contacting face 2121 and an imaginary plane where the soldering part 22 lies is preferably between 87 to 90 degrees, which is beneficial to a reliable mating. A corresponding angle between the first contacting portion 211 and the soldering part 22 may be similarly designed.

The contacts 2 or 5 are shown in the embodiment as two rows, though the present invention applies to a single row arrangement as well. As shown, the peripheral wall 12 has a pair of side walls 121 along a lengthwise direction and a pair of end walls 122 along a widthwise direction. The second contacting portion 212 has an inclined step 2122 between the planar outer contacting face 2121 and the connecting portion 213. The planar outer contacting face 2121 is formed by stamping the second contacting portion 212 to displace the material to have a protrusion 2123 on the opposite side. The bottom wall 40 of the insulative housing 4 of the receptacle connector 200 has grooves 401 for inserting the contacts 5. The peripheral wall 42 has a pair of side walls 421 along a lengthwise direction and a pair of end walls 422 along a widthwise direction. The inclined step 2122 of the second contacting portion 212 has an inclined face 21220 continuing the planar outer contacting face 2121 to define therebetween an angle “b” of about 135 degrees. The inclined step S122 similarly has an inclined face 51220 continuing the planar outer contacting face 5121 to form therebetween an angle of about 135 degrees. It is noted that with the angle “a” being between 87 to 90 degrees, during mating, the planar outer contacting face 2121 of the contact 2 facilitates the inclined step S122 of the contact 5 to slide thereon down an inclined slope, thereby drawing the plug connector 100 and the receptacle connector 200 toward each other to create a deep or more complete mating.

The holding member 3 is insert molded at the end wall 122 and includes a base 31, a pair of side plates 32, and a mounting portion 33. The side plate 32 has a latch 321 and a pair of embedding portions 322. The mounting portion 33 has a pair of soldering legs 331. The holding member 6 is insert molded at the end wall 422 and includes a U-shaped base 61, a soldering leg 62, and a pair of side plates 63. The side plate 63 has a vertical portion 631, an upper portion 632, and a lower portion 633. The vertical portion 631 has a dent 6311 for receiving the latch 321.

What is claimed is:

1. An electrical connector comprising:
an insulative housing; and
a plurality of contacts secured to the insulative housing, each contact having a generally U-shaped part and a soldering part, the U-shaped part having a first contacting portion, a second contacting portion, and a connecting portion between the first contacting portion and the second contacting portion; wherein
each of the first and second contacting portions has an outer contacting face; and
one of the first and second contacting portions extends from the connecting portion to incline toward the other contacting portion.

2. The electrical connector as claimed in claim 1, wherein the plurality of contacts are inserted molded with the insulative housing.

3. The electrical connector as claimed in claim 1, wherein the outer contacting face of the second contacting portion is planar.

4. An electrical connector assembly comprising:
a first connector including:
an insulative housing; and
a plurality of contacts secured to the insulative housing, each contact having a generally U-shaped part and a soldering part, the U-shaped part having a first contacting portion, a second contacting portion, and a connecting portion between the first contacting portion and the second contacting portion, each of the first and second contacting portions having an outer contacting face, one of the first and second contacting portions extending from the connecting portion to incline toward the other contacting portion; and
a second connector including:
an insulative housing; and
a plurality of contacts secured to the insulative housing, each contact having a resilient engaging part; wherein
during mating the first and second connectors, the resilient engaging part of the second connector contact engages the outer contacting faces of the U-shaped part of the first connector contact to draw the first and second connectors toward each other.

5. An electrical connector comprising:
an insulative housing; and
a plurality of contacts secured to the insulative housing, each contact having a generally upside-down U-shaped part and a soldering part extending horizontally, the U-shaped part having a first contacting portion, a second contacting portion, and a connecting portion between the first contacting portion and the second contacting portion; wherein
each of the first and second contacting portions has an outer contacting face; wherein
the second contact portion defines a planar outer contacting face and terminated at a free end of the second contact portion, and includes an inclined step linked to the connecting portion, said inclined step defining a inclined face continuing the planar outer contacting face with therebetween an angle around 135 degrees; wherein
an angle formed between the planar outer contacting face and the soldering part is smaller than 90 degrees while not less than 87 degrees.

6. The electrical connector as claimed in claim 5, wherein the U-shaped part is immovable with regard to the housing.
